(19) United States
(12) Patent Application Publication
(10) Pub. No.: US 2015/0092954 A1
(43) Pub. Date: Apr. 2, 2015

(54) Method and Apparatus for Sending a Control Signal to an Electronic Device

(71) Applicant: Motorola Mobility LLC, Libertyville, IL (US)

(72) Inventors: Oyeneye O. Coker, Miami, FL (US); Juan Alvira Fernandez, Miramar, FL (US); Matthew T. Hull, Sunrise, FL (US)

(73) Assignee: Motorola Mobility LLC, Libertyville, IL (US)

(21) Appl. No.: 14/068,309

(22) Filed: Oct. 31, 2013

Related U.S. Application Data
(60) Provisional application No. 61/884,663, filed on Sep. 30, 2013.

(51) Int. Cl. H04R 1/10; H04R 3/00

(52) U.S. Cl. CPC H04R 1/1041; H04R 3/00; H04R 2201/103
USPC 381/74

(57) ABSTRACT

A method and apparatus for sending a control signal to an electronic device includes an accessory (200) of the electronic device detecting activation of a first switch (204) of the accessory and, responsively, controlling a second switch (206) of the accessory to generate a first control signal that instructs the electronic device to enable a function while the first switch is activated. The accessory sends the first control signal to the electronic device over a microphone line (208) coupled to a microphone (210) of the accessory and configured to be coupled to the electronic device. For a specific embodiment, the method includes the accessory detecting deactivation of the first switch and, responsively, controlling the second switch (206) of the accessory to generate a second control signal to instruct the electronic device to disable the function, and sending the second control signal to the electronic device over the microphone line (208).

### FIELD OF THE DISCLOSURE

The present disclosure relates generally to sending a control signal to an electronic device from an accessory of the electronic device and more particularly to the accessory sending a control signal over a microphone line to enable a function on the electronic device.

### BACKGROUND

Mobile electronic devices, such as smartphones and phablets, continue to evolve through increasing levels of performance and functionality as manufacturers design products that offer consumers greater convenience and productivity. Today, a single smartphone can operate as a phone, two-way radio, media player, web browser, global-positioning-system receiver, camera, personal digital assistant, gaming device, and remote control where separate, dedicated devices would have been required at the turn of the century.

Advancements are also being made with user interfaces for intelligent electronic devices that place control of the devices' full functionality at users' fingertips while also being intuitive and easy to navigate. However, controlling such electronic devices using accessories, such as headphones, which are designed to be coupled to and operate with the electronic devices, pose certain challenges. For example, standard connectors, such as the four-conductor 3.5 millimeter mini plug, used to couple audio accessories to electronic devices are designed to maximize compatibility with a wide range of devices from different manufactures. However, standard connectors oftentimes allow for only a limited number of signal pathways to control a greater number of functions. Proprietary or nonstandard connectors could instead be used but at the expense of compatibility with fewer devices from a smaller number of manufacturers. Further, there is an expectation among consumers that the controls on accessories that operate feature-rich electronic devices, which incorporate the functionality of many individual devices, function the way the controls on the individual devices would.

### BRIEF DESCRIPTION OF THE FIGURES

The accompanying figures, where like reference numerals refer to identical or functionally similar elements throughout the separate views, together with the detailed description below, are incorporated in and form part of this specification, and serve to further illustrate embodiments of concepts that include the claimed invention, and explain various principles and advantages of those embodiments.

FIG. 1 is a block diagram of an electronic device with an accessory in accordance with some embodiments of the present teachings.

FIG. 2 is a schematic diagram of an accessory in accordance with some embodiments of the present teachings.

FIG. 3 is a schematic diagram of an accessory in accordance with some embodiments of the present teachings.

FIG. 4 is a schematic diagram of a four-pole connector of an accessory in accordance with some embodiments of the present teachings.

FIG. 5 is a logical flowchart illustrating a method for using two switches to enable a function on an electronic device in accordance with some embodiments of the present teachings.

FIG. 6 is a schematic diagram of control signals being sent to an electronic device in accordance with some embodiments of the present teachings.

FIG. 7 is a logical flowchart illustrating a method for sending control signals and voice data to an electronic device in accordance with some embodiments of the present teachings.

FIG. 8 is a schematic diagram of control signals and voice data being sent to an electronic device in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus wherein an accessory of an electronic device uses a microphone line connecting the accessory to the electronic device to send one or more control signals to the electronic device to enable and disable a function performed by the electronic device or to indicate the beginning and end of voice data sent to the electronic device. More specifically, in accordance with the teachings herein, a method performed by an accessory for sending a control signal to an electronic device includes the accessory detecting activation of a first switch of the accessory and, responsively, controlling a second switch of the accessory to generate a first control signal that instructs the electronic device to enable a function while the first switch is activated. The method further includes the accessory sending the first control signal to the electronic device over a microphone line coupled to a microphone of the accessory and configured to be coupled to the electronic device.

Also in accordance with the teachings herein, a method performed by an accessory for providing control signals and voice data to an electronic device includes the accessory detecting an activation of a first switch of the accessory and, responsively, controlling a second switch of the accessory to generate a first control signal that indicates a start of voice data. The method additionally includes the accessory sending the first control signal to the electronic device over a microphone line coupled to a microphone of the accessory and configured to be coupled to the electronic device. The method further includes the accessory receiving the voice data into the microphone and sending the voice data to the electronic device over the microphone line while the activation of the first switch is sustained. The method also includes the accessory detecting deactivation of the first switch and, responsively, controlling the second switch of the accessory to generate a second control signal that indicates a termination of the voice data. The method moreover includes the accessory sending the second control signal to the electronic device over the microphone line.

Further in accordance with the teachings herein, an accessory configured for sending control signals to an electronic device includes a microphone configured to be coupled to the electronic device using a microphone line and a semiconductor switching element coupled to the microphone line. The accessory additionally includes a control circuit coupled to the semiconductor switching element, wherein the control circuit is configured to control the semiconductor switching element to generate, when a mechanical switching element is activated, a first control signal on the microphone line to instruct the electronic device to enable a function, wherein the function remains enabled while the mechanical switching element is activated. Also included in the accessory is the mechanical switching element coupled to the control circuit, wherein the mechanical switching element is configured to provide an activation indication to the control circuit upon activation of the mechanical switching element, and the control circuit is configured to control the semiconductor switching element to generate the first control signal upon receipt of the activation indication.

For one embodiment, the mechanical switching element is further configured to provide a deactivation indication to the control circuit upon deactivation of the mechanical switching element. The control circuit is further configured to control the semiconductor switching element to, upon receipt of the deactivation indication, to instruct the electronic device to disable the function by performing one of: terminating generation of the first control signal on the microphone line, or generating a second control signal on the microphone line.

In another embodiment for which the microphone is further configured to receive voice data from a user of the accessory, the mechanical switching element is further configured to provide a deactivation indication to the control circuit upon deactivation of the mechanical switching element, and the control circuit is configured to control the semiconductor switching element to generate a second control signal upon receipt of the deactivation indication. The control circuit is further configured to control the semiconductor switching element to generate, when the mechanical switching element is deactivated, the second control signal on the microphone line to instruct the electronic device to disable the function, the microphone line is further configured to pass the voice data from the microphone to the electronic device while the mechanical switching element is activated.

For an additional embodiment, the accessory is a headset configured to be coupled with the electronic device using a four-pole tip-ring-ring-sleeve connector, and the mechanical switching element is a button configured to be activated when the button is pressed and deactivated when the button is released. The control circuit includes a processing element, wherein the processing element controls the semiconductor switching element to generate the first control signal upon receipt of the activation indication and to generate the second control signal upon receipt of the deactivation indication.

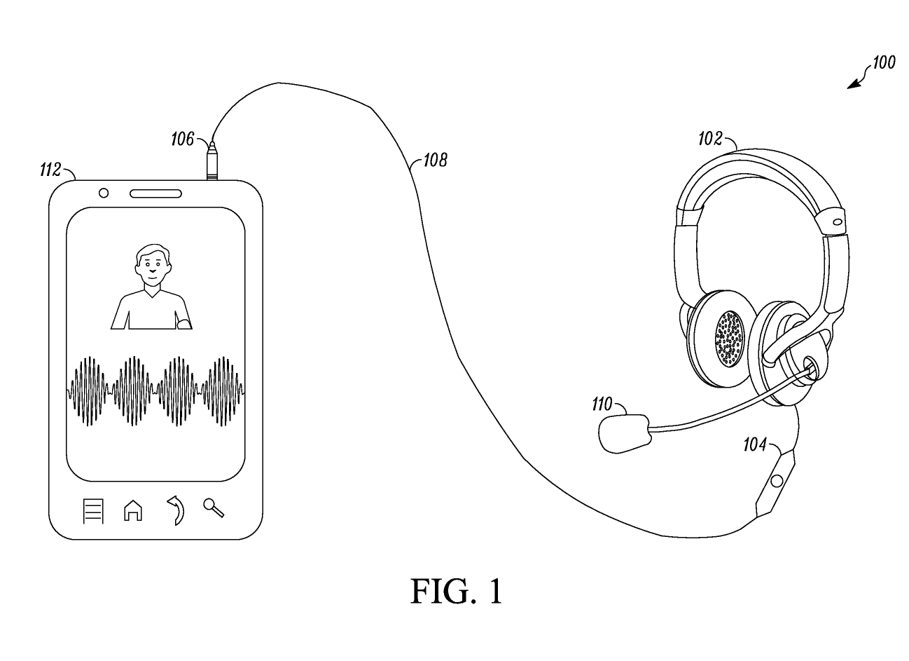

Referring now to the drawings, FIG. 1 shows a system 100, that includes an accessory 102 designed to couple to and operate with an electronic device 112 (also referred to herein simply as a device) in accordance with embodiments of the present teachings. The accessory 102, which includes a mechanical switch 104 and a microphone 110, couples to the device 112 by a connector 106 and a cord 108, which includes a microphone line.

While a smartphone and an accompanying headset are shown at 112 and 102, respectively, no such restriction is intended or implied as to the types of devices and accessories to which these teachings may be applied. Other suitable devices include, but are not limited to: personal digital assistants (PDAs); portable media players (e.g., MP3 players); personal computing devices, such as phablets and tablets; and wearable electronic devices, such as devices worn with a wristband or eyeglasses. For each device, an accessory can be any apparatus that includes a microphone line that couples to the device and by which the apparatus can signal the device.

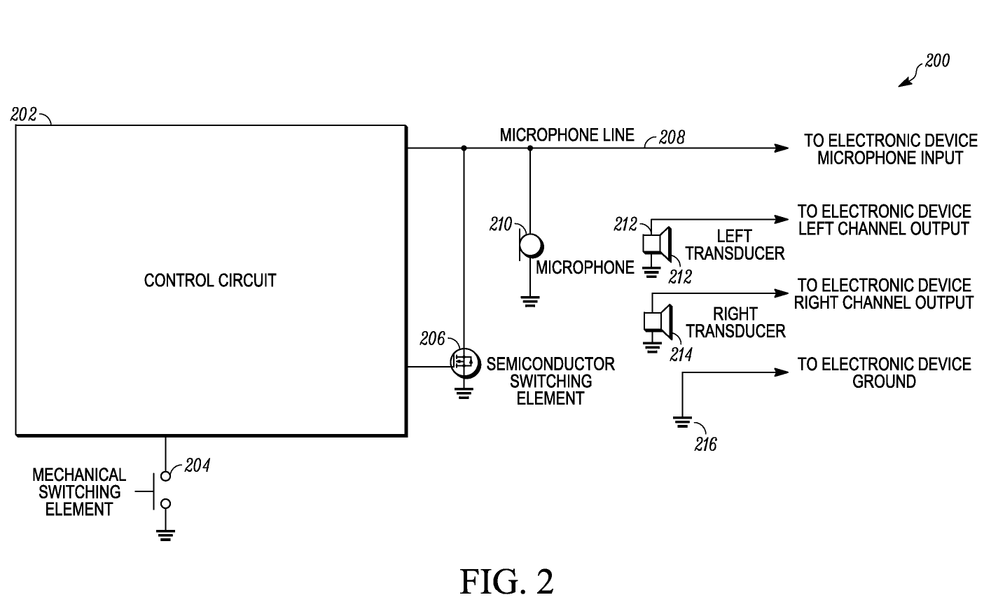

FIG. 2 shows a schematic diagram for an accessory 200. For one embodiment, the schematic diagram 200 represents the headset 102. Specifically, the schematic diagram 200 shows: a control circuit 202, a mechanical switching element 204, a semiconductor switching element 206, a microphone 210, a microphone line 208, left 212 and right 214 acoustical transducers, and a common reference 216 (also referred to herein as a reference voltage), which in this case is electrical ground, e.g., 0 Volts.

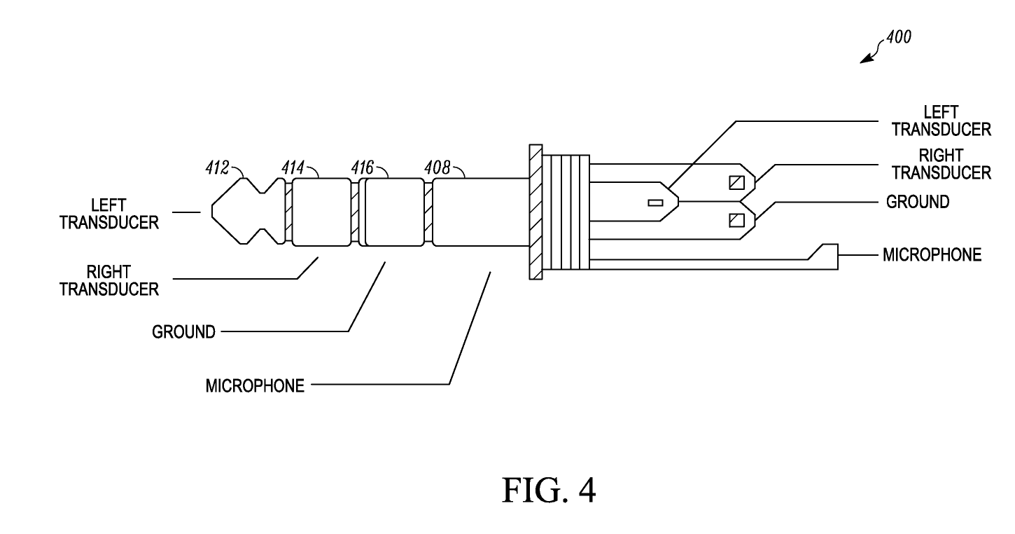

A limited number of accessory elements 202, 204, 206, 208, 210, 212, 214, 216 are shown at 200 for ease of illustration, but other embodiments may include a lesser or greater number of such elements in an accessory. Moreover, other elements needed for a commercial embodiment of an accessory that incorporates the elements shown at 200 are omitted from FIG. 2 for clarity in describing the enclosed embodiments. Additional elements included within the control circuit 202 for a particular accessory are shown in FIG. 4.

We now turn to a brief description of the elements within the schematic diagram 200. In general, the control circuit 202 is configured with functionality in accordance with embodiments of the present disclosure as described in detail below with respect to the remaining figures. “Adapted,” “operative,” “capable” or “configured,” as used herein, means that the indicated elements are implemented using one or more hardware devices such as one or more operatively coupled processing cores, memory devices, interfaces, and electronic components which may or may not be programmed with software and/or firmware as the means for the control circuit 202 to implement its desired functionality. Such functionality is supported by the other hardware shown in FIG. 2, including the accessory elements 204, 206, 208, 210, 212, 214, 216.

Continuing with the brief description of the accessory elements shown at 200, as included, for instance, within the accessory 102, the control circuit 202 is configured to detect when the mechanical switching element 204, which for a particular embodiment represents the mechanical switch 104, is activated and deactivated. As used herein, a mechanical switching element (also referred to as a mechanical switch or a first switch) is an electrical component that includes a set of electrical contacts which can break or interrupt the flow of electric current from one conductor to another. A mechanical switching element for an accessory is designed to be operated manually by a user of the accessory. For a particular embodiment, the mechanical switching element 204 is a button that is activated when pressed by a user and deactivated when released by the user. As shown, the mechanical switching element 204 completes a connection to ground 216 when activated and interrupts the connection to ground when deactivated. In an alternate embodiment, the mechanical switching element 204 interrupts the connection to ground 216 when activated and completes the connection to ground when deactivated.

The control circuit 202 is also configured to control the semiconductor switching element 206 (which represents and is also referred to herein as a second switch of an accessory) to generate a control signal on the microphone line 208. For an embodiment, the semiconductor switching element 206 represents an N-type metal-oxide semiconductor (NMOS). The microphone line 208, which connects the microphone 210 to an electronic device, carries a microphone bias voltage (e.g., 2 volts) used to supply power to the microphone 210. The semiconductor switching element 206, under the control of the control circuit 202, shorts the microphone line 208 to ground 216 for finite intervals of time (e.g., 50-200 milliseconds) thereby creating a control signal on the microphone line 208 as a sequence of different voltages.

For one embodiment, the control signal mainly uses two voltages. The first voltage is the bias voltage, occurring when the semiconductor switching element 206 is “open” or “OFF,” wherein no current flows through the switching element 206. The second voltage is the common reference 216 (e.g., 0V), occurring when the semiconductor switching element 206 is “closed” or “ON,” wherein current flows through the switching element 206 to complete a connection between the microphone line 208 and ground 216. For another embodiment, the semiconductor switching element 206 shorts the microphone line 208 to ground 216 through one or more resistive elements allowing the control signal to include additional voltages having values between the bias voltage and ground 216. The process of controlling the semiconductor switch 206 to generate a sequence of two or more different voltages on the microphone line 208 to create a control signal is referred to herein as modulating the bias voltage on the microphone line 208.

When the semiconductor switching element 206 is not being used to generate a control signal on the microphone line 208 (i.e., while the bias voltage is not being interrupted) the microphone 210 is configured to receive an acoustic signal and to convert the acoustic signal to an electronic data signal carried by the microphone line 208. For an embodiment, the electronic data signal represents an analog data signal. In a further embodiment, the analog data signal represents voice data resulting from a user of the accessory 200 speaking into the microphone 210.

The left 212 and right 214 transducers convert electronic audio signals received from an electronic device into acoustical pressure waves that a user of the accessory 200 can hear. For an embodiment, the left 212 and right 214 transducers represent the left and right speakers, respectively, of a stereo headset, such as the headset 102.

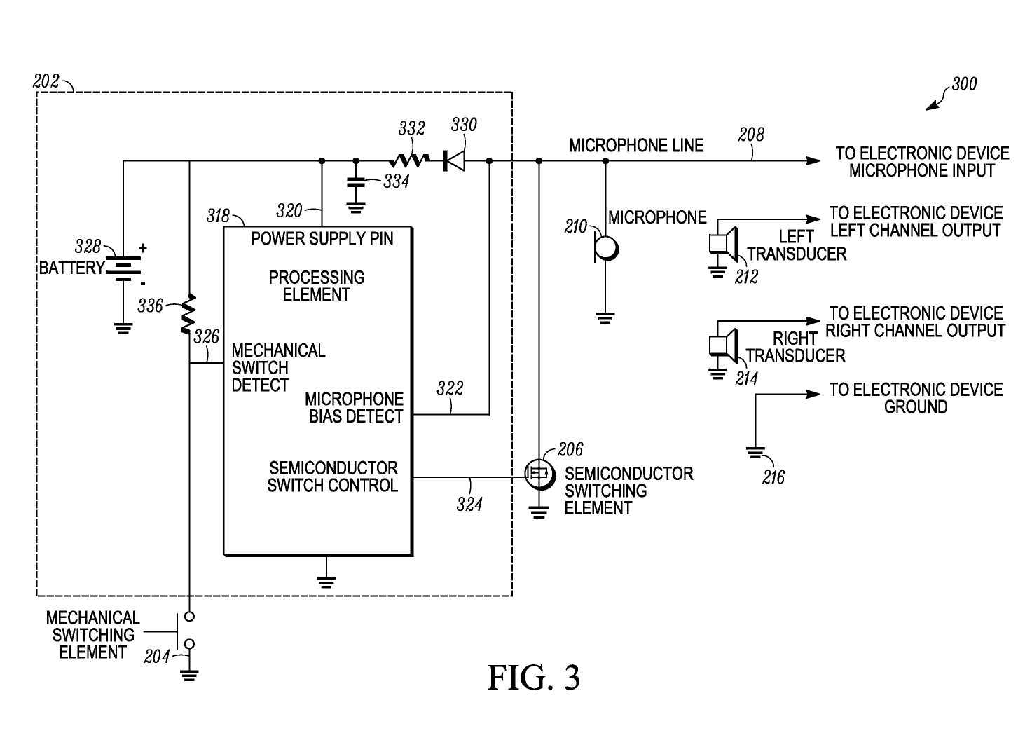

FIG. 3 presents a schematic diagram 300, consistent with the schematic diagram 200, that shows accessory elements included within the control circuit 202 in accordance with a particular embodiment of the present teachings. Specifically, FIG. 3 shows a processing element 318, a battery 328, a diode 330, a first resistor 332, a capacitor 334, and a second resistor 336 coupled as shown within the control circuit 202. The processing element 318, in turn, includes a power supply pin 320, a microphone bias detect pin 322, one or more semiconductor switch control pins 324, and a mechanical switch detect pin 326 coupled to accessory elements as shown within FIG. 3.

The processing element 318 possesses, for instance, arithmetic logic and registers for digitally processing activation and deactivation indications received into the pin 326 from the mechanical switching element 204. The processing element 318 further provides the signals, e.g., voltage signals, at the pin 324 to operate the semiconductor switching element 206 in a manner consistent with the embodiments described herein. For at least one embodiment, the processing element 318 is implemented as a system-on-chip (SoC) that supports the operation of the semiconductor switch 206. In at least one other embodiment, the processing element 318 is integrated with programmable flash memory. For a particular embodiment, the processing element 318 is an 8-bit microcontroller.

The power supply pin 320 (e.g., designated as Vcc or V+) of the processing element 318 connects with and enables the processing element 318 to draw power from the microphone line 208. While the processing element 318 is modulating the bias voltage on the microphone line 208 to generate a control signal, the battery 328 and the capacitor 334 supply the processing element 318 with power to keep it from “browning out” as the semiconductor switching element 206 shorts the microphone line 208 to ground 216. For an embodiment, the battery is a coin cell that “fills in” any remaining “dips” in the bias voltage the capacitor 334 is unable to filter out. The resistor 332 prevents the capacitor 334 from loading the bias voltage by drawing too much current from the microphone line 208, and the diode 330 prevents the capacitor 334 and the battery 328 from “washing out” the voltage modulation placed on the electronic device side (i.e., the anode side) of the microphone line 208. In a particular embodiment, the resistor 332 and the capacitor 334 have values of 10K ohms and 330 microfarads, respectively.

Activating the mechanical switching element 204 shorts the mechanical switch detect pin 326 to ground 216 in this embodiment. The resistor 336, which for an embodiment has a value of 470K ohms, minimizes the load placed on the microphone line 208 when the mechanical switching element 204 is activated. Deactivating the mechanical switching element 204 restores the previous voltage on the mechanical switch detect pin 326. Using a voltage discriminator, for example, the processing element 318 detects when the mechanical switching element 204 is activated and deactivated.

In an optional embodiment, a second mechanical switch (not shown) is connected to the processing element 318 along with the first mechanical switch 204. The second mechanical switch is, for example, connected to ground 216 opposite the mechanical switch detect pin 326 through a resistor such that a voltage applied to the mechanical switch detect pin 326 when the second mechanical switch is activated is different from the voltage applied when the first mechanical switch 204 is activated. Alternatively, the second mechanical switch can be connected to a second mechanical switch detect pin (not shown) of the processing element 318. This allows the processing element 318 to identify which mechanical switch is activated.

The semiconductor switch control pin 324 allows the processing element 318 to apply a voltage to a gate of the semiconductor switching element 206, which is connected in series between the microphone line 208 and ground 216. The voltage applied to the gate allows for conduction between a source and a drain of the semiconductor 206, thereby dropping or shorting out the bias voltage on the microphone line 208. The processing element 318 restores the bias voltage on the microphone line 208 by removing, or reducing to below a threshold value for the semiconductor switching element 206, the voltage that the semiconductor switch control pin 324 applies to the gate of the semiconductor switching element 206. The microphone bias detect pin 322 allows the processing element 318 to monitor the bias voltage on the microphone line 208. For an embodiment, the microphone bias detect pin 322 allows the processing element 318 to receive control signals sent by the electronic device 112 using the microphone line 208.

In an embodiment, the microphone line 208, the left 212 and right 214 transducer, and ground 216 shown on the right-hand side of schematic diagram 300 are connected by a cord having four conductors, such as the cord 108, to a four-pole connector, such as the connector 106.

FIG. 4 shows a four-pole connector 400, in accordance with embodiments of the present teachings. Specifically, FIG. 4 shows a tip-ring-ring-sleeve (TRRS) connector, consistent with the Cellular Telecommunications and Internet Association (CTIA) standard, that in different embodiments can be either a quarter-inch connector or an eighth-inch connector. The tip 412 and the first ring 414 connect with the left 212 and right 214 transducer, respectively, while the second ring 416 connects with ground 216. The sleeve 408 connects with the microphone 210 via the microphone line 208. In another embodiment, consistent with the Open Mobile Terminal Platform (OMTP) standard, the positions of the ground 416 and microphone 408 contacts of the connector 400 are reversed. For further embodiments, the left 412 and right 414 transducer, ground 416, and microphone 408 contacts for the connector 400 may be arranged in any order. Having a single contact share control signals and voice data provides five-pole functionality while using a standard four-pole connector.

For a particular embodiment, the accessory 300 performs a handshake exchange with an electronic device, such as the device 112, to indicate its capability of being able to provide control signals over the microphone line 208. For example, when the electronic device 112 is coupled to the accessory 300, the device 112 uses its connection to the microphone line 208 to send a signal to the accessory 300. This signal queries the accessory 300 to determine if the accessory 300 is an intelligent accessory with the capability of generating control signals on the microphone line 208. The microphone bias detect pin 322 detects the signal sent by the electronic device 112 and recognizes it (e.g., from its timing and/or its modulation) as a query of the accessory's capability. The processing element 318 controls the semiconductor switching element 206 to modulate the microphone line 208 with a programmed response to answer the query and complete the handshake exchange with the electronic device 112.

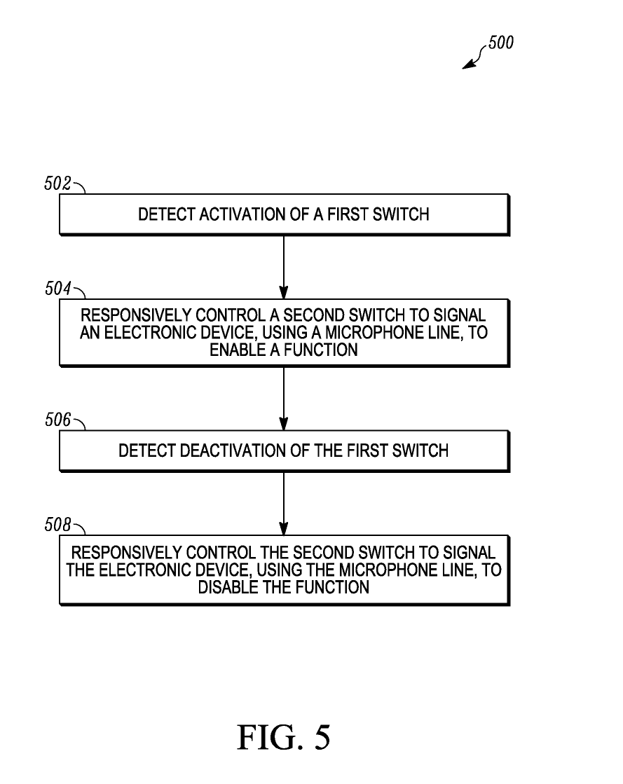

FIG. 5 shows a logical flowchart 500 indicating actions performed by an accessory, taken to be the accessory 102 as represented by the schematic diagrams 200, 300, 400, to enable and disable a function of the electronic device 112 in accordance with some embodiments. Specifically, the flowchart 500 indicates the control circuit 202 of accessory 102 detecting 502 activation of the first switch 204 (e.g., the button 104). Responsively, the control circuit 202 controls 504 the second switch 206 to signal the electronic device 112, using the microphone line 208, to enable a function. For an embodiment, the control circuit 202 signals the electronic device 112 by controlling the second switch 206 to modulate the microphone bias voltage of the microphone line 208 to generate a first control signal on the microphone line 208. The electronic device 112 receives the first control signal over a conductor of the four-conductor cord 108 that connects the microphone line 208 with the microphone contact 408 of the connector 400. Upon receiving the first control signal, the electronic device 112 enables the function.

For multiple embodiments, the function enabled on the electronic device 112 is based on an application executing on the electronic device 112. Each application interprets the first control signal differently. Where a media player is actively running on the electronic device 112, for example, a user of the device 112 presses the button 104 to adjust the volume for the media player, to advance the media player to a next media file in a playlist, or to fast forward within the media file being played. For specific embodiments, the electronic device 112 applies the function continuously as the user holds the button 104. The volume keeps increasing, the media files keep advancing, or the current media file keeps fast forwarding. In further embodiments, the rate at which the electronic device 112 applies the function increases as the user holds the button 104. The volume increases by larger increments, the media files advance in shorter time intervals, or the current media file fast forwards more quickly. For one embodiment, the first control signal enables a shutter release when a camera application is active on the electronic device 112. Holding the button 104 causes the electronic device 112 to take snapshots continuously.

In some embodiments, the user activating the optional second mechanical switch results in the control circuit 202 controlling the semiconductor switch 206 to generate an alternate control signal on the microphone line 208 that differs from the first control signal resulting from the activation of the first mechanical switch 204. This alternate control signal enables a function on the electronic device that may be application dependent but that differs from the function enabled by the first control signal. For example, the alternate control signal resulting from the activation of the second mechanical switch might instruct the electronic device 112 to decrease the volume for a media player (rather than increase it), to skip to a previous media file (rather than to the next), or to rewind a current media file (rather than fast forward it).

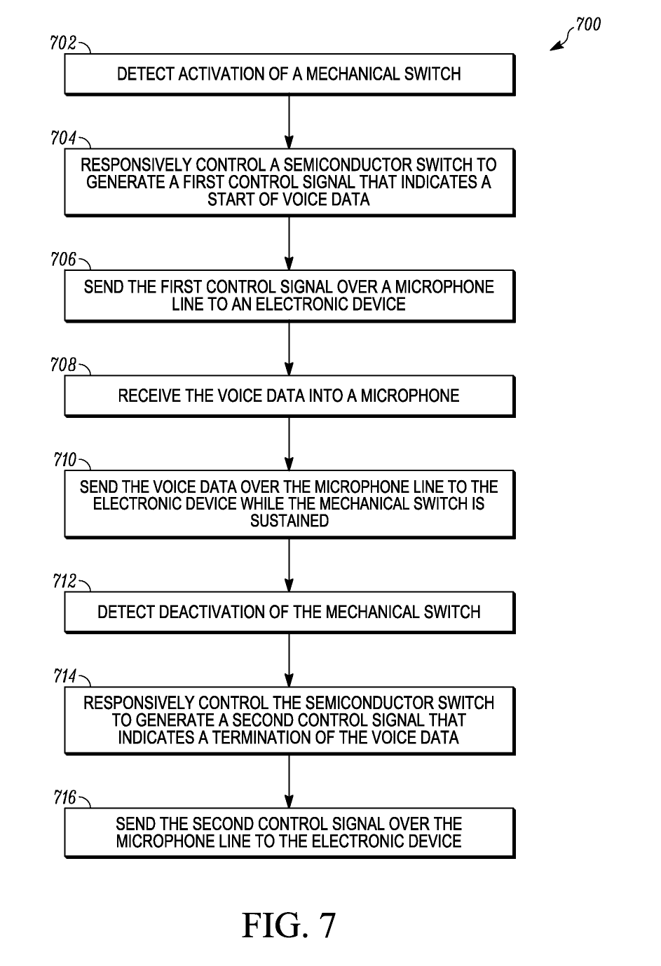

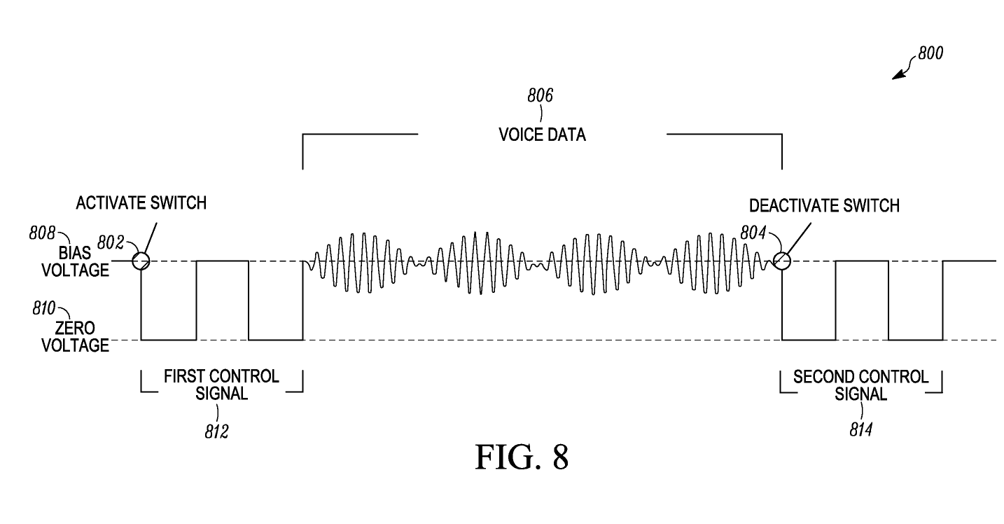

For additional embodiments, the first control signal enables different functions on the electronic device 112. Where the user is using the electronic device 112 as a push-to-talk (PTT) radio, for example, the function is a PTT function. In another embodiment, the function is a voice recognition function enabling the user to issue verbal commands (e.g., voice activated speed-dial telephony) or dictate a text message. Generating and using control signals in connection with voice data is described in greater detail with reference to FIGS. 7 and 8.

When the control circuit 202 detects 506 deactivation of the first switch 204, the control circuit 202 responsively controls 508 the second switch 206 to signal the electronic device 112, again using the microphone line, to disable the function enabled by the first control signal. In a first particular embodiment, the control circuit 202 instructs the electronic device 112 to disable the function by terminating generation of the first control signal.

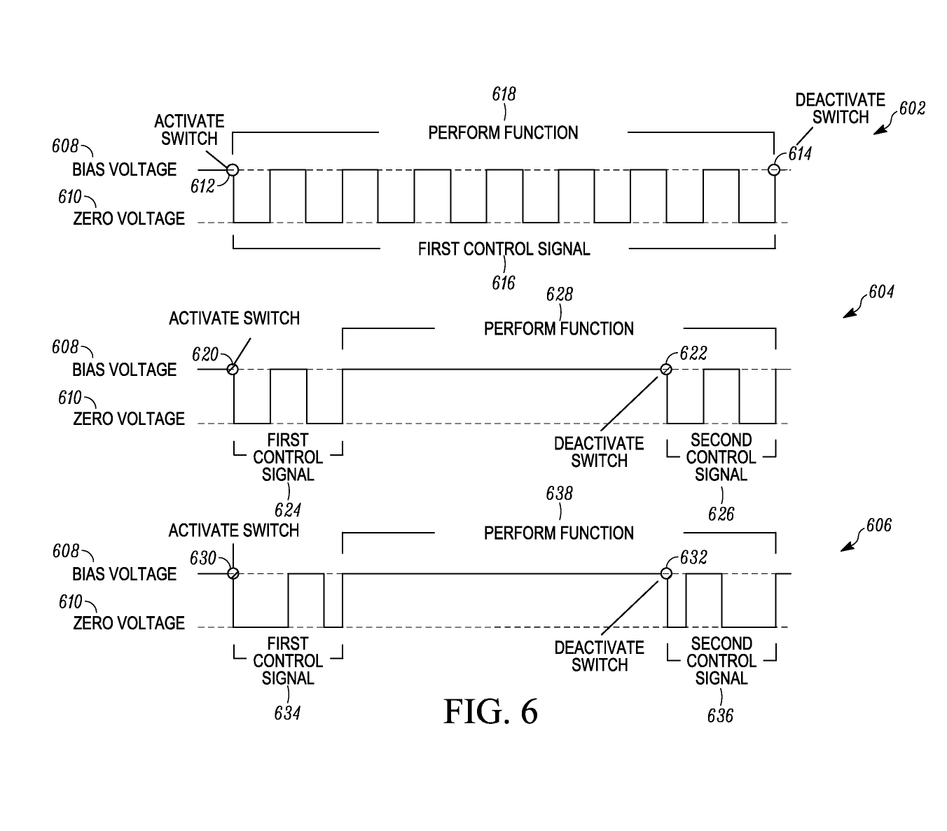

FIG. 6 shows a schematic diagram 602 illustrating a first control signal, the termination of which disables the function that was enabled when the first control signal was received and processed. The diagram 602 shows activation 612 and deactivation 614 of the mechanical switching element 204; a first control signal 616; two voltages, a microphone bias voltage 608 and a zero voltage 610 (representing the ground 216 or reference voltage); and an interval 618 over which the enabled function is performed.

A user of device 112 activates 612 the mechanical switch 104 (e.g., presses the button) and the control circuit 202 of the accessory 102 controls the semiconductor switch 206 to modulate the voltage on the microphone line 208 between the bias voltage 608 and ground 610. The resulting first control signal 616 is a sequence of square wave pulses having a duty cycle that corresponds to when the control circuit 202 turns the semiconductor switch 206 ON and OFF. As shown, the duration of the individual pulses (corresponding to when the semiconductor switch 206 is OFF) matches the time between pulses (corresponding to when the semiconductor switch 206 is ON). In other embodiments, the ratio of the pulse width to the inter-pulse distance can take on values other than unity or vary as a function of time.

In the embodiment shown, the first control signal 616 is sustained until the control circuit 202 terminates it when the user deactivates 614 the mechanical switch 104 (e.g., releases the button). The electronic device 112 performs 618 the function while the first control signal 616 is sustained. The device 112 enables the function when it initially receives the first control signal 616 and disables the function when it no longer receives the first control signal 616. Although not shown at 618, there is a short duration or “lag time” between when the first control signal 616 begins and when the electronic device 112 detects that the first control signal 616 has begun.

In a second particular embodiment, the control circuit 202 instructs the electronic device 112 to disable the function enabled by the first control signal by generating a second control signal. The control circuit 202 of the accessory 102 detects deactivation of the first switch 204 and, responsively, controls the second switch 206 of the accessory 102 to generate a second control signal, sent to the electronic device 112 over the microphone line 208, to instruct the electronic device 112 to disable the function. This is illustrated by schematic diagram 604, which shows activation and deactivation of the switch 104 at 620 and 622, respectively. The diagram 604 also shows both a first 624 and a second 626 control signal along with an interval 628 over which the function is performed.

As before, the control circuit 202 controls the semiconductor switch 206 to generate the first control signal 624 when the user activates 620 the mechanical switch 204. The duration of the first control signal 624, however, is shorter than the first control signal 616 illustrated at 602. The first control signal 624 may last only a few hundred milliseconds, or any other amount of time sufficient to signal the electronic device 112 to enable a function. After the first control signal 624 is terminated, the electronic device 112 continues to perform 628 the enabled function until the device 112 receives (and processes) the second control signal 626. The second control signal 626 is initiated when the user deactivates 622 the mechanical switch 204. Therefore, for both of the above first and second particular embodiments, the electronic device 112 enables a function when the user presses a button, performs the function while the user holds the button, and disables the function when the user releases the button.

For some embodiments, the first and second control signals have the same signal pattern. Such an embodiment is illustrated at 604 where both signals 624 and 626 include a single square pulse with an amplitude determined by the bias voltage 608 and bordered on both sides by an equal duration of zero voltage 610.

Alternatively, the first and second control signals can have a different signal pattern. A schematic diagram 606 shows both a first 634 and second 636 control signal that each include a single square wave pulse with an amplitude determined by the bias voltage 608 and bordered by dissimilar durations of zero voltage 610. As the mechanical switch 204 is activated 630, the first control signal 634 begins with a longer duration of zero voltage 610 and ends with a shorter duration of zero voltage 610. Conversely, as the mechanical switch is deactivated 632, the second control signal 636 begins with a shorter duration of zero voltage 610 and ends with a longer duration of zero voltage 610. The different signal patterns allow the electronic device 112 to more readily differentiate between a function-enabling (first) control signal and a function-disabling (second) control signal. The function is performed 638 by the electronic device 112 from when the device 112 processes the first control signal 634 until when the device 112 processes the second control signal 636.

For a number of embodiments, rather than enabling and disabling a specific function, the first and second control signals indicate a beginning and end, respectively, of voice data sent to an electronic device by an accessory. For three embodiments, the electronic device uses the voice data in connection with PTT functionality, dictation capability, and command recognition. For other embodiments, the control signals indicate that voice data sent after a particular first control signal or sent between particular first and second control signals relates to a particular corresponding voice-related function. In further embodiments, the first and second control signals can also enable and disable the particular corresponding voice-related function.

FIG. 7 shows a logical flow diagram 700 illustrating a method performed by an accessory, taken to be the accessory 102 as represented by the schematic diagrams 200, 300, 400, for sending control signals to an electronic device, taken to be the electronic device 112. The control signals define a window within which the accessory 102 captures voice data and transmits it to the device 112. When a user of the electronic device 112 activates the mechanical switch 204 (e.g., presses the button 104), the control circuit 202 of the device 112 detects 702 the activation of the switch 204 and responsively controls 704 the semiconductor switch 206 to generate a first control signal that indicates a start of voice data. The first control signal is sent 706 over the microphone line 208 and represents a first modulation of the microphone bias voltage on the microphone line 208.

After activating the mechanical switch 204, the user speaks into the microphone 210. The microphone 210 receives 708 the acoustic pressure waves resulting from the speech and converts them into electronic voice data. While the user sustains activation of the mechanical switch 204, the accessory receives and sends 710 the voice data over the microphone line 208 to the electronic device 112, which the electronic device 112 uses in connection with voice-related functionality.

For one embodiment, the voice data represents a verbal command given to the electronic device 112 by the user. The user presses the button 104, speaks the command into the microphone 210, and releases the button when he is through speaking the command. The control circuit 202 detects 712 the release of the button 104 and responsively controls 714 the semiconductor switch 206 to generate a second control signal that indicates a termination of the voice data. The second control signal represents a second modulation of the microphone bias voltage on the microphone line 208, which for an embodiment, is different from the first modulation. In another embodiment, the first and second control signals have the same modulation of the microphone bias voltage on the microphone line 208. The accessory 112 sends 716 the second control signal over the microphone line 208 to the electronic device 112 following the voice data to signal the device 112 that the user has finished giving his verbal command. In a further embodiment, the first and second control signals indicate to the electronic device 112 to enable and disable a voice recognition and/or speech processing function that interprets the verbal command.

A speech processing module of the device 112 or software running on the device 112 can, for example, analyze phonemes, the phonetic building blocks of speech, within the voice data. The electronic device 112 compares phonemes for the voice data against phonemes stored within a database to calculate confidence scores for different commands. When the confidence score for a specific command exceeds a threshold score, the device 112 performs that command, which should be the spoken command. Because the exact beginning and end of the spoken command is indicated by the first and second control signal, respectively, the device 122 can eliminate extraneous acoustic data that is not part of the spoken command from the phoneme comparison. This allows the device 112 to identify the spoken command with greater confidence.

FIG. 8 shows a schematic diagram 800 graphically illustrating the method 700 performed by the accessory 102 for sending voice data to the electronic device 112. The diagram 800 shows activation 802 and deactivation 804 of the mechanical switching element 204 (representing the button 104); first 812 and second 814 control signal; two voltages, the microphone bias voltage 808 and a zero voltage 810 (representing the ground 216 or reference voltage); and an interval 806 over which voice data is sent to the electronic device 112. For an embodiment, a user uses the smartphone 112 as a PTT radio. The user begins by pressing 802 the button 104 when he is ready to speak. The control circuit 202 detects the activation of the mechanical switching element 204 and responsively controls the semiconductor switch 206 to generate the first control signal 812 on the microphone line 208.

Modulating the microphone bias voltage to generate a control signal temporarily disables the microphone 210 because the bias voltage 808 that the microphone 210 needs to function is intermittently shorted to ground 810. For this reason, in an embodiment, the duration of the first control signal 812 is not made longer than necessary for the electronic device 112 to reliably process the signal. For specific embodiments, the duration of first control signal 812 is kept between 50 and 200 milliseconds (ms). In other embodiments, involving devices having faster or slower electronics, the duration of the first control signal may be less than 50 ms or greater than 200 ms, respectively. During this time, the electronic device might be communicating with communication infrastructure (e.g., a cellular network servicing the device 112) to set up the PTT call.

The first control signal 812 instructs the electronic device to send a PTT floor request to the communication infrastructure. Over the interval 806, while holding the button 104, the user speaks into the microphone 210, and the resulting voice data is sent to the electronic device 112 over the microphone line 208. When the user finishes speaking, he releases the button 104, which the control circuit 202 detects. The control circuit 202 responsively controls the semiconductor switching element 206 to modulate the microphone bias voltage 808 and generate the second control signal 814, which is sent to the electronic device 112 over the microphone line 208. The second control signal 814 instructs the electronic device 112 to send a PTT floor release to the communication infrastructure. During the PTT call, the method 702 and signal 812 is repeated as the electronic device 112 makes subsequent floor requests when the user pushes the button 104 to speak and the signal 814 occurs when the user releases the button 104 after speaking.

As shown at 800, the first 812 and second 814 control signals have the same modulation (i.e., the same modulation pattern) of the microphone bias voltage 808 on the microphone line 208. In further embodiments, the first 812 and second 814 control signals that indicate the beginning and end, respectively, of voice data may also have different modulations, for example, different numbers of pulses, different pulse widths, and/or different inter-pulse distances.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an accessory for sending a control signal to an electronic device, the method comprising:
detecting activation of a first switch of the accessory and, responsively, controlling a second switch of the accessory to generate a first control signal that instructs the electronic device to enable a function while the first switch is activated; and
sending the first control signal to the electronic device over a microphone line coupled to a microphone of the accessory and configured to be coupled to the electronic device.

2. The method of claim 1, wherein controlling the second switch to generate the first control signal comprises:
controlling the second switch to modulate a microphone bias voltage on the microphone line.

3. The method of claim 1, wherein the function is based on an application executing on the electronic device.

4. The method of claim 3, wherein the function comprises at least one of:
a push-to-talk function; or
a voice recognition function.

5. The method of claim 3, wherein the function comprises at least one of:
adjusting volume for a media player;
advancing to a next media file for the media player; or
fast forwarding within a media file for the media player.

6. The method of claim 1 further comprising:
detecting deactivation of the first switch and, responsively, terminating generation of the first control signal to instruct the electronic device to disable the function.

7. The method of claim 1 further comprising:
detecting deactivation of the first switch and, responsively, controlling the second switch of the accessory to generate a second control signal to instruct the electronic device to disable the function;
sending the second control signal to the electronic device over the microphone line.

8. The method of claim 7, wherein the first control signal and the second control signal have a same signal pattern.

9. The method of claim 7, wherein the first control signal and the second control signal have a different signal pattern.

10. A method performed by an accessory for providing control signals and voice data to an electronic device, the method comprising:
detecting an activation of a first switch of the accessory and, responsively, controlling a second switch of the accessory to generate a first control signal that indicates a start of voice data;
sending the first control signal to the electronic device over a microphone line coupled to a microphone of the accessory and configured to be coupled to the electronic device;
receiving the voice data into the microphone, and sending the voice data to the electronic device over the microphone line while the activation of the first switch is sustained;
detecting deactivation of the first switch and, responsively, controlling the second switch of the accessory to generate a second control signal that indicates a termination of the voice data; and
sending the second control signal to the electronic device over the microphone line.

11. The method of claim 10, wherein the first control signal instructs the electronic device to send a push-to-talk floor request, and the second control signal instructs the electronic device to send a push-to-talk floor release.

12. The method of claim 10, wherein the voice data comprises:
a voice command to the electronic device.

13. The method of claim 10, wherein the first control signal comprises:
a first modulation of a microphone bias voltage on the microphone line.

14. The method of claim 13, wherein the second control signal comprises:
a second modulation of the microphone bias voltage on the microphone line.

15. The method of claim 10, wherein the first control signal and the second control signal comprise a same modulation of a microphone bias voltage on the microphone line.

16. The method of claim 10 further comprising:
performing a handshake exchange with the electronic device to indicate capability of providing control signals over the microphone line.

17. An accessory configured for sending control signals to an electronic device, the accessory comprising:
a microphone configured to be coupled to the electronic device using a microphone line;
a semiconductor switching element coupled to the microphone line;
a control circuit coupled to the semiconductor switching element, wherein the control circuit is configured to control the semiconductor switching element to generate, when a mechanical switching element is activated, a first control signal on the microphone line to instruct the electronic device to enable a function, wherein the function remains enabled while the mechanical switching element is activated; and
the mechanical switching element coupled to the control circuit, wherein the mechanical switching element is configured to provide an activation indication to the control circuit upon activation of the mechanical switching element, and the control circuit is configured to control the semiconductor switching element to generate the first control signal upon receipt of the activation indication.

18. The accessory of claim 17, wherein:
the mechanical switching element is further configured to provide a deactivation indication to the control circuit upon deactivation of the mechanical switching element; and
the control circuit is further configured to control the semiconductor switching element to, upon receipt of the deactivation indication, to instruct the electronic device to disable the function by performing one of:
terminating generation of the first control signal on the microphone line; or
generating a second control signal on the microphone line.

19. The accessory of claim 17, wherein:
the microphone is further configured to receive voice data from a user of the accessory;
the mechanical switching element is further configured to provide a deactivation indication to the control circuit upon deactivation of the mechanical switching element, and the control circuit is configured to control the semiconductor switching element to generate a second control signal upon receipt of the deactivation indication;
the control circuit is further configured to control the semiconductor switching element to generate, when the mechanical switching element is deactivated, the second control signal on the microphone line to instruct the electronic device to disable the function; and
the microphone line is further configured to pass the voice data from the microphone to the electronic device while the mechanical switching element is activated.

20. The accessory of claim 19, wherein:
the accessory is a headset configured to be coupled with the electronic device using a four-pole tip-ring-ring-sleeve connector;
the mechanical switching element is a button configured to be activated when the button is pressed and deactivated when the button is released; and
the control circuit comprises a processing element, wherein the processing element controls the semiconductor switching element to generate the first control signal upon receipt of the activation indication and to generate the second control signal upon receipt of the deactivation indication.
